(19) United States
(12) Patent Application Publication
(10) Pub. No.: US 2013/0047186 A1
(43) Pub. Date: Feb. 21, 2013

(54) Method to Enable Proper Representation of Scaled 3D Video

(71) Applicants: James Alan Strothman, Johns Creek, GA (US); James Michael Blackmon, Lawrenceville, GA (US)

(72) Inventors: James Alan Strothman, Johns Creek, GA (US); James Michael Blackmon, Lawrenceville, GA (US)

(73) Assignee: Cisco Technology, Inc., San Jose, CA (US)

(21) Appl. No.: 13/212,769

(22) Filed: Aug. 18, 2011

(51) Int. Cl. H04N 13/00; H04N 21/462

(52) U.S. Cl. 725/46; 725/39; 348/E13.064

(57) ABSTRACT

A custom interface depth may be provided. A content stream, such as a three-dimensional television signal, comprising a plurality of video planes may be displayed. In response to receiving a request to adjust a depth of at least one of the video planes, the display depth of the requested video plane may be adjusted relative to at least one other video plane. The depth of a video plane containing a scaled version of the three-dimensional television signal may be adjusted relative to a video plane displaying an electronic program guide.

### BACKGROUND

Customization of 3DTV user interface element positions may be provided. In conventional systems, user interface elements are required to share a video plane in the 3D television environment with other elements, such as a content stream. A program guide may be provided including a scaled video window to allow the user to continue viewing the current program while browsing the program guide. Current systems do not provide for presentation of a scaled 3D video positioned with appropriate offset from the program guide such that the video appears “behind” the program guide.

### BRIEF DESCRIPTION OF THE DRAWINGS

The accompanying drawings, which are incorporated in and constitute a part of this disclosure, illustrate various embodiments. In the drawings:

FIG. 1 is a block diagram of an operating environment;

FIG. 2 is a block diagram illustrating a 3D-TV signal;

FIGS. 3A-3C are block diagrams illustrating adjusting an interface depth in an over-under video plane configuration;

FIGS. 4A-4C are block diagrams illustrating adjusting an interface depth in a side-by-side video plane configuration;

FIG. 5 is a flow chart of a method for providing a custom interface depth for a scaled 3D video in a program guide; and

FIG. 6 is a block diagram of a computing device.

### DESCRIPTION OF EXAMPLE EMBODIMENTS

### Overview

Consistent with embodiments of the present disclosure, systems and methods are disclosed for providing a customization of a 3DTV user interface. A content stream, such as a three-dimensional television signal, comprising a plurality of video planes may be displayed. In response to receiving a request to adjust a depth of at least one of the video planes, the display depth of the requested video plane may be adjusted relative to at least one other video plane.

It is to be understood that both the foregoing general description and the following detailed description are examples and explanatory only, and should not be considered to restrict the application's scope, as described and claimed. Further, features and/or variations may be provided in addition to those set forth herein. For example, embodiments of the present disclosure may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of this disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A 3D television (3D-TV) is a television set that employs techniques of 3D presentation, such as stereoscopic capture, multi-view capture, or 2D plus depth, and a 3D display—a special viewing device to project a television program into a realistic three-dimensional field. In a 3D-TV signal such as that described in the 3D portion of the High Definition Multimedia Interface HDMI 1.4a specification, which is hereby incorporated by reference in its entirety, three-dimensional images may be displayed to viewing users using stereoscopic images. That is, two slightly different images may be presented to a viewer to create an illusion of depth in an otherwise two-dimensional image. These images may be presented as right-eye and left-eye images that may be viewed through lenses such as anaglyphic (with passive red-cyan lenses), polarizing (with passive polarized lenses), and/or alternate-frame sequencing (with active shutter lenses).

The 3D-TV signal may comprise multiple planes of content. For example, main content may be included on one or more video planes, a channel guide may occupy another plane, and a scaled version of the currently viewed video content may be displayed on another plane. Consistent with embodiments of this disclosure, each of these planes may be displayed at different relative depths to a viewing user, such as where the scaled video plane appears “behind” the program guide plane to the user. An offset value may be employed to ensure a desired depth level for the scaled video plane.

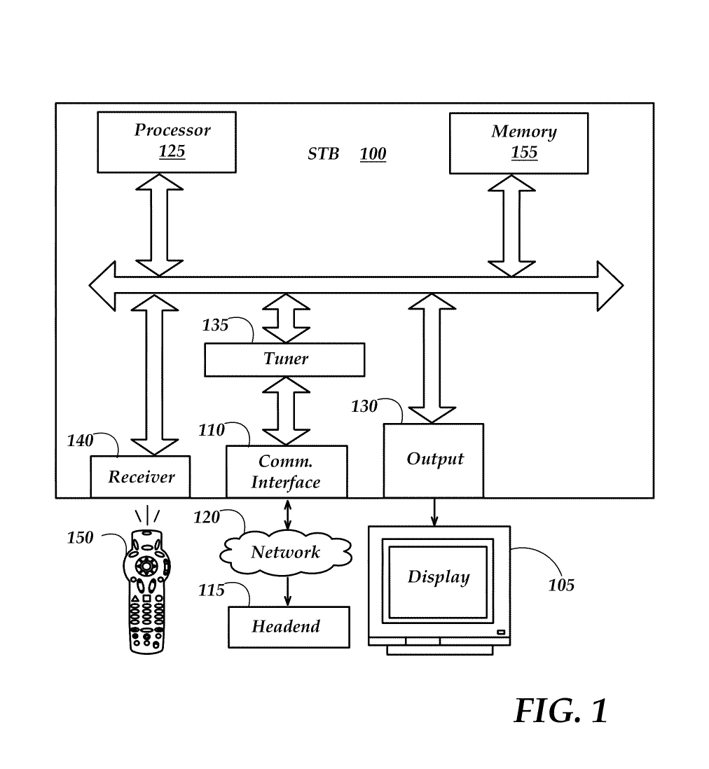

FIG. 1 is a block diagram illustrating an operating environment for providing customization of 3D-TV user interface element positions. A set-top-box (STB) 100 may be situated, for example, within the residence or business of a subscriber. It may be integrated into a device that has a display, such as a computing device, or it may be a stand-alone unit that couples to an external display, such as a display 105 included with a computer or a television. STB 100 may process media transported in television signals for presentation or playback to a subscriber. STB 100 may comprise a communications interface 110 for receiving the RF signals, which may include media such as video, audio, graphical and data information, from a cable system headend 115. STB 100 may communicate with headend 115 via a network 120, such as a hybrid fiber-coax (HFC) cable television distribution network or an IP network (e.g. the Internet). STB 100 may also provide any reverse information (such as admission control data as required by a subscriber that has purchased a bi-directional service) to headend 115. STB 100 may further comprise a processor 125 for controlling operations of STB 100, including a video output port such as an RF output system 130 for driving display 105, a tuner system 135 for tuning into a particular television channel to be displayed and for sending and receiving data corresponding to various types of media from the headend.

The (“out of band management”) OOB coupled with an upstream transmitter may enable STB 100 to interface with the network so that STB 100 may provide upstream data to the network, for example via the QPSK or QAM channels. This allows a subscriber to interact with the network. Encryption may be added to the OOB channels to provide privacy.

Additionally, STB 100 may comprise a receiver 140 for receiving externally generated information, such as user inputs or commands for other devices. STB 100 may also include one or more wireless or wired communication interfaces (not shown), for receiving and/or transmitting data to other devices. For instance, STB 100 may feature USB (Universal Serial Bus) (for connection to a USB camera or microphone), Ethernet (for connection to a computer), IEEE-1394 (for connection to media devices in an entertainment center), serial, and/or parallel ports. A computer or transmitter may for example, provide the user inputs with buttons or keys located either on the exterior of the terminal or by a hand-held remote control device 150 or keyboard that includes user-actuated buttons. In the case of bi-directional services, a user input device may include audiovisual information such as a camera, microphone, or videophone. As a non-limiting example, STB 100 may feature USB or IEEE-1394 for connection of an infrared wireless remote control or a wired or wireless keyboard, a camcorder with an integrated microphone or to a video camera and a separate microphone.

STB 100 may simultaneously decompress and reconstruct video, audio, graphics and textual data that may, for example, correspond to a live program service. This may permit STB 100 to store video and audio in memory in real-time, to scale down the spatial resolution of the video pictures, as necessary, and to composite and display a graphical user interface (GUI) presentation of the video with respective graphical and textual data while simultaneously playing the audio that corresponds to the video. The same process may apply in reverse and STB 100 may, for example, digitize and compress pictures from a camera for upstream transmission.

A memory 155 of STB 100 may comprise a dynamic random access memory (DRAM) and/or a flash memory for storing executable programs and related data components of various applications and modules for execution by STB 100. Memory 155 may be coupled to processor 125 for storing configuration data and operational parameters, such as commands that are recognized by processor 125. Memory 155 may also be configured to store user preference profiles associated with viewing users.

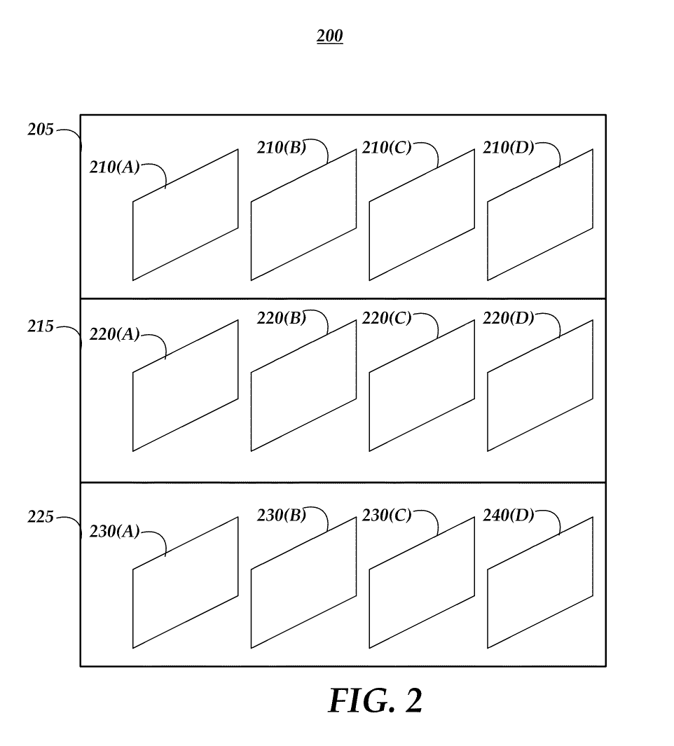

FIG. 2 is a block diagram illustrating a 3D-TV content stream 200. Content stream 200 may comprise a sequence of video frames, each of which may comprise a plurality of video planes. For example, a first frame 205 may comprise a first plurality of video planes 210(A)-(D), a second frame 215 may comprise a second plurality of video planes 215(A)-(D), and a third frame 225 may comprise a third plurality of video planes 230(A)-(D). Each video plane may comprise different data; for example, video plane 210(A) may comprise a main content plane, video plane 210(B) may comprise a program guide plane, video plane 210(C) may comprise an information banner plane, and video plane 210(D) may comprise a scaled video plane comprising a scaled version of the content displayed on video plane. Consistent with embodiments of this disclosure, respective planes of each frame (e.g., video plane 210(A), video plane 220(A), and video plane 230(A)) may each correspond to the same data stream. That is, in the given example, each of video plane 210(A), video plane 220(A), and video plane 230(A) may correspond to the main content associated with 3D-TV content stream 200.

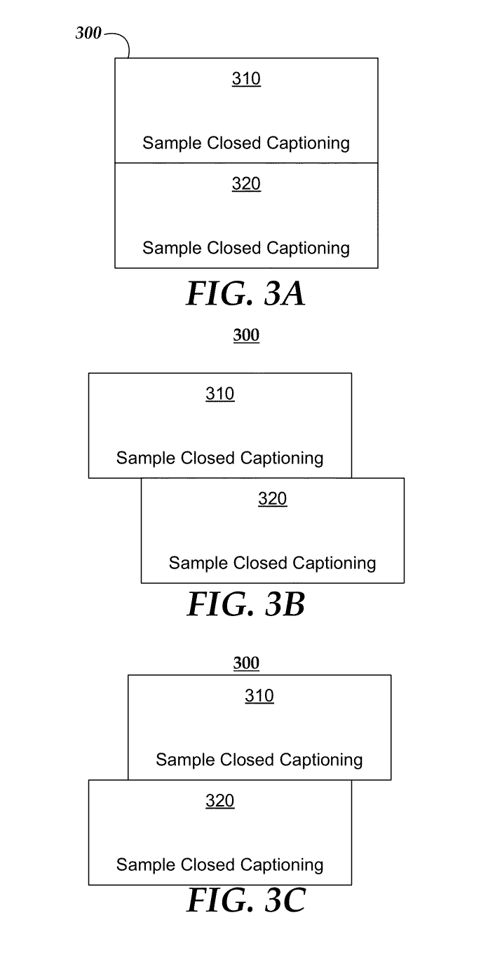

FIG. 3A is a block diagram illustrating an over-under configured 3D-TV video plane 300. For example, each of the sequence of video frames in content stream 200 may comprise a frame of a 1920×1080p resolution video stream, such as first frame 205. Video plane 300 may correspond to any of first plurality of video planes 210(A)-(D) and may comprise a left-eye image 310 situated over a right eye image 320. Left-eye image 310 and right eye image 320 may be directed to a viewing user's correct eye through the use of coordinated lenses as described above to create the appearance of a three-dimensional effect. The depth of each frame may be enabled by adjusting the vertical spacing between the images. When left eye image 310 and right eye image 320 have no horizontal offset, the frame may appear at screen depth. Adjusting right eye image 320 right and left eye image 310 left may make the object appear in front of the screen depth (i.e., closer to the viewer); adjusting right eye image 320 left and left eye image 310 right may make the image appear to recede.

FIG. 3B is a block diagram illustrating over-under configured 3D-TV video plane 300 adjusted to decrease the apparent depth of video plane 300. By adjusting left-eye image 310 to the left and right-eye image 320 to the right to create a horizontal offset, the apparent depth of video plane 300 may be adjusted so that the 3D image appears closer to the viewer. Adjusting the offset between the right and left eye images may change the apparent depth to the user due to, for example, the angle of incidence of the images to a set of polarized viewing lenses.

FIG. 3C is a block diagram illustrating over-under configured 3D-TV video plane 300 adjusted to increase the apparent depth of video plane 300. By moving left-eye image 310 to the right and right-eye image 320 to the left to create a horizontal offset, the apparent depth of video plane 300 may be adjusted so that the 3D image appears further from the viewer.

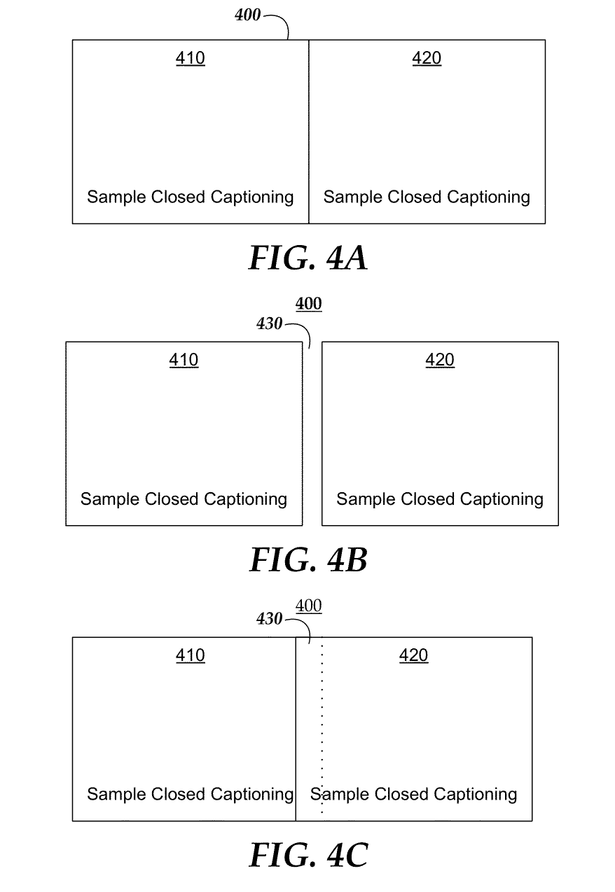

FIG. 4A is a block diagram illustrating a side-by-side configured 3D-TV video plane 400. For example, each of the sequence of video frames in content stream 200 may comprise a frame of a 1920×1080p resolution video stream, such as first frame 205. Video plane 400 may correspond to any of first plurality of video planes 210(A)-(D) and may comprise a left-eye image 410 situated next to a right eye image 420. Left-eye image 410 and right eye image 420 may be directed to a viewing user's correct eye through the use of coordinated lenses as described above to create the appearance of a three-dimensional effect. The depth of each frame may be enabled by adjusting the horizontal spacing between the images. When left eye image 410 and right eye image 420 have no horizontal separation, the frame may appear at screen depth. Adjusting right eye image 420 to the right and left eye image 410 to the left will make the object appear in front of the screen depth (i.e., closer to the viewer); adjusting right eye image 420 to the left and left eye image 410 to the right will make the image appear to recede.

FIG. 4B is a block diagram illustrating side-by-side configured 3D-TV video plane 400 adjusted to decrease the apparent depth of video plane 300. By separating left-eye image 410 and right-eye image 420 to create a vertical gap 430, the apparent depth of video plane 400 may be adjusted so that the 3D image appears closer to the viewer.

FIG. 4C is a block diagram illustrating side-by-side configured 3D-TV video plane 400 adjusted to increase the apparent depth of video plane 400. By moving left-eye image 410 and right-eye image 420 closer together to create an area of vertical overlap 440, the apparent depth of video plane 400 may be adjusted so that the 3D image appears further from the viewer.

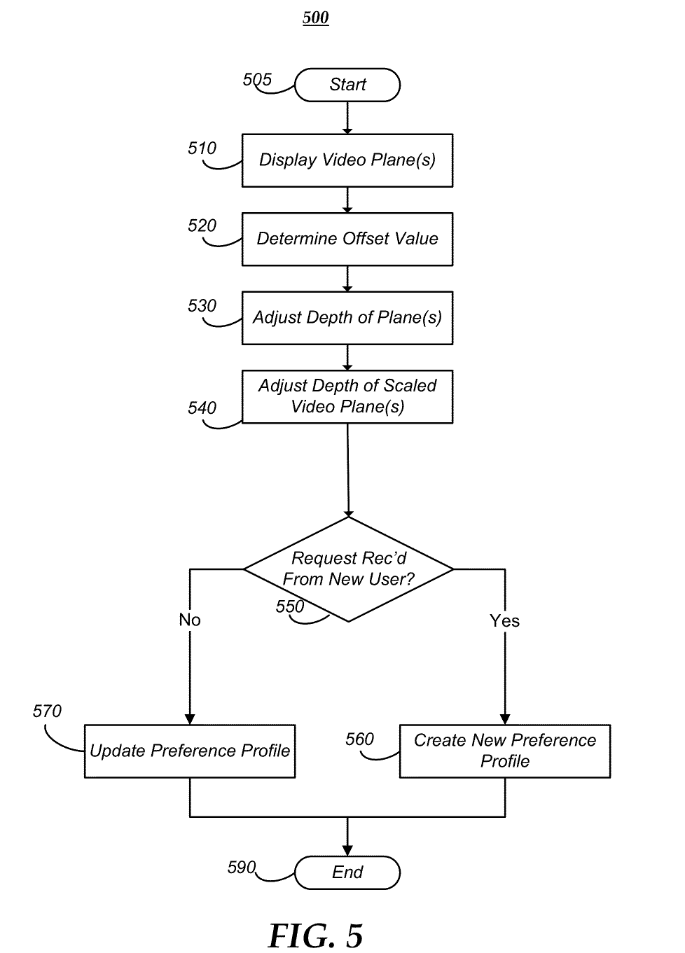

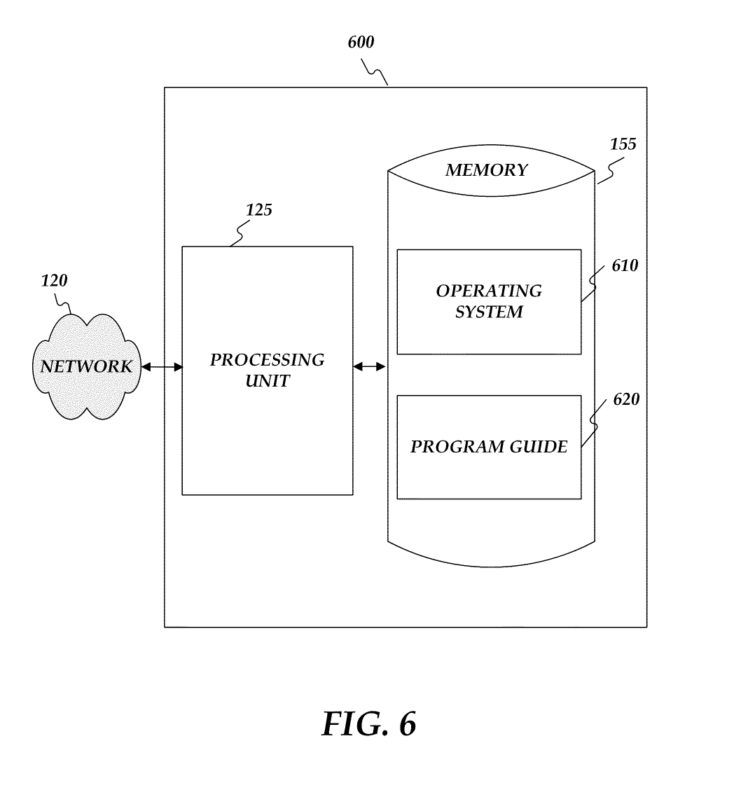

FIG. 5 is a flow chart setting forth the general stages involved in a method 500 consistent with embodiments of the disclosure for providing a customized interface depth offset between a program guide plane and a scaled video frame. Method 500 may be implemented using a computing device 600 as described in more detail below with respect to FIG. 6. Ways to implement the stages of method 500 will be described in greater detail below. Method 500 may begin at starting block 505 wherein STB 100 may receive a command from a user through remote 150. The command may indicate a user request to view a program guide.

The method may proceed to stage 510 where computing device 600 may display a plurality of video content planes including at least a program guide plane. For example, during television viewing, STB 100 may receive a video stream from headend 115, decode the video stream into a plurality of video frames, and output the resulting content to display 105. Similarly, program guide information may be received and displayed on display 105 upon request. The program guide display may include a video plane containing a scaled version of the video content being viewed by the user prior to requesting the program guide.

Method 500 may then advance to stage 520 where computing device 500 may determine an offset value representing the desired depth of the scaled video plane to the program guide plane. For example, STB 100 may store a plurality of profiles in memory 155. Each profile may have an associated offset value. The offset value may be a numeric representation of the desired depth between the scaled video plane to the program guide plane. In embodiments of this disclosure, the offset value may be a user-configurable value or determined by system conditions. In embodiments of this disclosure, a default offset value may be used and/or STB 100 may select a most recently used offset value.

Method 500 may then advance to stage 530 where computing device 500 may adjust an apparent depth of at the scaled video plane. For example, in over-under configuration 300, STB 100 may adjust the separation between left-eye image 310 and right-eye image 320 to create an apparent depth of video plane 300. This may comprise, for example, setting the apparent depth of a closed-captioning plane to an offset value that allows the viewing user to comfortably focus on the scaled video as it appears to sit behind the program guide plane.

Method 500 may then advance to stage 540 where computing device 500 may adjust the depth of the scaled video plane in relation to the program guide plane. For example, if the viewing user selects the program guide, the depth of the scaled video plane may be decreased by decreasing the separation between left-eye image 310 and right-eye image 320.

Method 500 may then advance to stage 550 where computing device 500 may determine if the request was received from a new user profile. For example, STB 100 may determine that the current display depth of the scaled video plane in relation to the program guide plane is at a default depth and/or no profiles have previously been stored. Consistent with embodiments of this disclosure, STB 100 may store a new preferred depth offset value for the selected video plane in a preference profile in memory 155.

If the request to adjust the plane's depth was received from a new user, method 500 may advance to stage 560 where computing device 500 may create a new preference profile associated with the user. For example, STB 100 may create a preference profile comprising values associated with the current depth for each of plurality of video planes 210(A)-(D). Consistent with embodiments of this disclosure, the preference profile may comprise only those depth values that deviate from a default depth value for the respective video plane.

If the request to adjust the plane's depth was not received from a new user, method 500 may advance to stage 570 where computing device 500 may create a new preference profile associated with the user. For example, STB 100 may update the user's existing preference profile comprising values associated with the current depth for each of plurality of video planes 210(A)-(D). The method 500 may then end at stage 590.

An embodiment consistent with this disclosure may comprise a system for providing a customized interface depth. The system may comprise a memory storage and a processing unit coupled to the memory storage. The processing unit may be operative to display a content stream comprising a plurality of video planes, receive a request to display a program guide, and, in response to receiving the request, modify the display depth of the first video plane relative to at least one second video plane of the plurality of video planes, wherein the first video plane is associated with a scaled three-dimensional television signal and the second video plane is associated with program guide information. The request may be received, for example, from a remote control device. The display depth of the video planes may be modified by a pre-determined offset value.

Another embodiment consistent with this disclosure may comprise a system for providing a customized interface depth. The system may comprise a memory storage and a processing unit coupled to the memory storage. The processing unit may be operative to display a content stream comprising a plurality of video planes, identify a viewer of the content stream, and adjust a depth of a first video plane of the plurality of video planes relative to a second video plane of the plurality of video planes according to a preference profile associated with the identified user, wherein the first video plane is a scaled version of three-dimensional video and the second plane is a program guide plane. The processing unit may be further operative to receive a request to adjust the depth of the first video plane relative to the second video plane and, in response to receiving the request, modify the display depth of the first video plane relative to the second video plane.

Yet another embodiment consistent with this disclosure may comprise a system for providing a customized interface depth. The system may comprise a memory storage and a processing unit coupled to the memory storage. The processing unit may be operative to display a content stream comprising a plurality of video planes associated with a three-dimensional television program, receive a request to display an electronic program guide, display at least one first video plane of the plurality of video frames, wherein the at least one first video plane is a scaled version of the three-dimensional television program, receive a request to adjust a depth of the at least one first video plane, and in response to receiving the request, modifying the display depth of the at least one first video plane. The processing unit may be further operative to receive a selection of at least one second video plane of the plurality of video planes, receive a request to adjust a depth of the at least one second video plane, and in response to receiving the request, modify the display depth of the at least one second video plane.

FIG. 6 illustrates a computing device 600. Computing device 600 may include processing unit 125 and memory 155. Memory 155 may include software configured to execute application modules such as an operating system 610 and/or a program guide interface 620. Computing device 600 may execute, for example, one or more stages included in method 500 as described above with respect to FIG. 5. Moreover, any one or more of the stages included in method 500 may be performed on any element shown in FIG. 1.

Computing device 600 may be implemented using a personal computer, a network computer, a mainframe, a computing appliance, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

Embodiments of the present disclosure, for example, are described above with reference to block diagrams and/or operational illustrations of methods, systems, and computer program products according to embodiments of this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and are the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

What is claimed is:

1. A method comprising:
displaying a content stream comprising a plurality of video planes;
receiving a request to display a program guide; and
in response to receiving the request, modifying the display depth of a first video plane relative to at least one second video plane of the plurality of video planes, wherein the first video plane is associated with a scaled three-dimensional television signal and the second video plane is associated with program guide information.

2. The method of claim 1, wherein the request is received from a remote control.

3. The method of claim 1, wherein the display depth is modified by a pre-determined offset value.

4. The method of claim 3, wherein the first video plane comprises a live three-dimensional television broadcast.

5. The method of claim 1, wherein the second video plane is associated with a three-dimensional program guide.

6. The method of claim 1, further comprising storing the modified display depth in a user preference profile.

7. The method of claim 1, wherein the first video plane comprises a stereoscopic image comprising a right-eye image and a left-eye image.

8. The method of claim 7, wherein the left-eye image and the right-eye image comprise an over-under configuration.

9. The method of claim 7, wherein the left-eye image and the right-eye image comprise a side-by-side configuration.

10. The method of claim 7, wherein modifying the display depth of the first video plane relative to at least one second video plane comprises increasing a separation between the right-eye image and the left-eye image.

11. The method of claim 7, wherein modifying the display depth of the first video plane relative to at least one second video plane comprises decreasing a separation between the right-eye image and the left-eye image.

12. An apparatus comprising:
a memory; and
a processor coupled to the memory, wherein the processor is operative to:
display a content stream comprising a plurality of video planes,
identify a user preference profile, and
adjust a depth of a first video plane of the plurality of video planes relative to a second video plane of the plurality of video planes according to a preference profile associated with the identified user, wherein the first video plane is a scaled version of three-dimensional video and the second plane is a program guide plane.

13. The apparatus of claim 12, wherein the processor is further operative to:
receive a request to adjust the depth of the first video plane relative to the second video plane; and
in response to receiving the request, modify the display depth of the first video plane relative to the second video plane.

14. The apparatus of claim 13, wherein the processor is further operative to:
determine whether the request to adjust the depth of the first video plane relative to the second video plane was received from a new user; and
in response to determining that the request to adjust the depth of the first video plane relative to the second video plane was received from the new user, create a new preference profile associated with the new user.

15. The apparatus of claim 14, wherein the processor is further operative to:
in response to determining that the request to adjust the depth of the first video plane relative to the second video plane was not received from the new user, update the preference profile of user.

16. A method comprising:
displaying a content stream comprising a plurality of video planes associated with a three-dimensional television program;
receiving a request to display an electronic program guide;
displaying of at least one first video plane of the plurality of video planes, wherein the at least one first video plane is a scaled version of the three-dimensional television program;
receiving a request to adjust a depth of the at least one first video plane; and
in response to receiving the request, modifying the display depth of the at least one first video plane.

17. The method of claim 16, further comprising:
receiving a selection of at least one second video plane of the plurality of video planes;
receiving a request to adjust a depth of the at least one second video plane; and
in response to receiving the request, modifying the display depth of the at least one second video plane.

18. The method of claim 17, further comprising storing the modified display depth of the at least one first video plane and the at least one second video plane as a preference profile associated with a user.

19. The method of claim 16, wherein the at least one second video plane comprises at least one of the following: a main content frame, a program guide frame, a closed caption frame, a channel identifier frame, a recorded program list frame, a playback status indicator frame, and an information banner frame.

20. The method of claim 16, wherein modifying the display depth of the at least one first video plane comprises adjusting a horizontal offset of a left-eye portion and a right-eye portion of the at least one first video plane.
